(19) United States
(12) Patent Application Publication
(10) Pub. No.: US 2005/0007237 A1
(43) Pub. Date: Jan. 13, 2005

(54) Device for emitting high frequency signals, particularly in an identification system

(75) Inventor: Martin Meyer, Nuernberg (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/851,204

(22) Filed: May 24, 2004

(30) Foreign Application Priority Data
May 22, 2003 (DE) 10323214.1

(51) Int. Cl. H04B 3/00

(52) U.S. Cl. 340/10.1; 340/5.61

(57) ABSTRACT

A device for emitting high-frequency signals, which has a modulator for the amplitude shift keying of input signals, a Class-E amplifier and a transmitting antenna. Such a device can be used in an identification system as a component of a read/write device, from which modulated data signals are transmitted to a mobile data carrier. Input signals (DS) are subjected to amplitude shift keying by controlling a plurality of parallel-connected tri-state outputs of a digital integrated circuit (IC) with a control unit (CTR). The tri-state outputs switch a transistor of the Class-E amplifier at the carrier frequency. As a result, a nearly harmonic current with a constant amplitude is generated in the transmitting antenna.

The following disclosure is based on German Patent Application No. 103 23 214.1, filed on May 22, 2003, which is incorporated into this application by reference in its entirety.

### FIELD OF AND BACKGROUND OF THE INVENTION

The invention relates to a device for emitting High-Frequency (“HF”) Signals, particularly in an identification system. Contactless identification systems use contactless transmission methods. Such contactless identification systems are used, for example, to identify persons or goods being moved, e.g., in conjunction with transportation systems. In contactless identification systems, the necessary data is transmitted by a read/write device over a contactless data transmission link, e.g., over an air interface, to a mobile data carrier and is also transmitted in the opposite direction. The contactless identification method makes it possible to acquire data while the data carrier moves past the read/write device, without the need for the data carrier to be inserted into, or swiped through, the read/write device. Data carriers of this type are used, among other things, as tickets with an electronically reloadable credit balance, such that the corresponding amount is automatically deducted when the means of transport is used.

German Patent DE 32 42 551 C2 discloses an arrangement for identifying an object. This arrangement has an identification device, which emits electromagnetic energy in the form of electromagnetic waves via a transmitter equipped with an antenna. The arrangement further has a code carrier disposed on the object to be identified, which picks up the emitted electromagnetic energy via a receiver. The receiver of the code carrier can be switched or adjusted between different loads in accordance with the code, such that, if the load in the code carrier changes, the electromagnetic field on the transmitter emitting the energy is changed according to the identification device, and the low-frequency current or voltage change resulting from the field change is evaluated with respect to the code contained therein.

German Patent DE 198 44 631 A1 discloses a system for monitoring, controlling, tracking, and handling objects. This system has at least one stationary or mobile read/write device and at least one mobile data carrier, which is fixed directly to the object. The data carrier has a means for storing identification data and object-specific data, as well as a means for the wireless transmission of the data to the read/write device. The mobile data carrier further has a means for acquiring and storing environmental data and/or other measured values. The identification data, object-specific data, environmental data and/or other measured values are either sent automatically using a broadcast method, or are transmitted to the read/write device upon request by the read/write device. Further, the read/write device has a microprocessor, a memory, an input/output unit, an interface, a transceiver, and a power supply.

European Publication EP 0 171 433 B1 discloses an identification system, which has at least one reader/exciter and a passive integrated transponder. The reader/exciter has an exciter, a signal conditioner, as well as demodulation and detection circuits. The exciter consists of an AC signal source and an energy amplifier, which supplies an exciter signal with high current intensity and voltage to an exciter/query coil via a capacitor. The query coil and the capacitor are selected such that resonance is present in the exciter signal frequency, so that the voltage applied to the coil is substantially larger than the voltage present at the output of the amplifier. The exciter has a crystal-controlled oscillator, the frequency-divided output signal of which is used to control a high-energy switch driver, which in turn drives the exciter/query coil. The high-energy switch driver contains two Metal-Oxide-Semiconductor Field-Effect Transistors (“MOSFETs”), which are interconnected in a push-pull arrangement. The outputs of the MOSFETs are connected to the exciter/query coil via a resistor network and coupling capacitors. The resistor network is provided to reduce the losses of the MOSFETs during the switching transitions.

Also known are so-called Class-E amplifiers. Class-E amplifiers have a transistor which operates as a switch. To reduce power dissipation, an effort is always made to keep the switching time of the transistor as short as possible. The load network connected to the transistor is provided to configure the voltage and current curve in such a way that a high voltage never occurs simultaneously with a high current in the transistor.

### SUMMARY OF THE INVENTION

An object of the present invention is to provide a device for emitting HF signals useable in an identification system. Another object is to provide such a device that has a relatively small number of components, particularly in comparison to conventional devices.

According to one formulation of the invention, this object, and other objects, are attained by a device for emitting high-frequency signals, including: a modulator configured to perform amplitude shift keying of input signals; a Class-E amplifier which is connected to the modulator; and a transmitting antenna. Advantageous embodiments and further refinements of the invention are also set forth below.

Some of the advantages of the present invention include, in particular, that the claimed device for emitting HF signals has a reduced number of components compared to conventional units. Furthermore, the claimed device works more efficiently and requires only a low supply voltage.

Moreover, suitably controlling the parallel-connected tri-state outputs of a digital integrated circuit makes it possible to connect, disconnect, and bring to a high-resistance state, each one of these outputs. If, for example, all the tri-state outputs are connected, then a high current flows through the transmitting coil or the transmitting antenna. If some of the tri-state outputs are in a high-resistance state, then a lower current flows through the transmitting coil or the transmitting antenna. This results in an amplitude shift keying of the current flowing through the transmitting antenna, and of the magnetic field generated by this current.

To obtain the shortest possible falling edges of the envelope curve, all the tri-state outputs can be switched off during an initial blanking time, such that the switching transistor of the Class-E amplifier is reliably inhibited. Analogously, shorter rise times of the edges of the envelope can be obtained by activating additional outputs.

If the tri-state outputs are additionally wired with resistors connected in series thereto, it is possible to achieve a different weighting and thereby an even greater range of the possible gate currents of the MOSFETs of the Class-E amplifier.

In addition, using a coil of the Class-E amplifier as the transmitting antenna further reduces the number of the required components.

As an alternative thereto—if required by the corresponding application—the transmitting antenna can be arranged at a distance from the Class-E amplifier and can be connected therewith via a line and a matching network. The role of the matching network is to match the amplifier and the antenna to the ohmic resistance of the line.

A device consistent with the present invention can be advantageously used in an identification system and, in that system, can be a component of the read/write device, from which modulated data signals are transmitted to a mobile data carrier.

### BRIEF DESCRIPTION OF THE DRAWINGS

The invention will now be described in greater detail, by way of example, with reference to the embodiments depicted in the figures, in which:

FIG. 1 shows a block diagram of an identification system in which the present invention can be used;

FIG. 2 shows a circuit diagram of a first illustrative and non-limiting embodiment of a device for emitting HF signals consistent with the present invention;

FIG. 3 shows a circuit diagram of a second illustrative and non-limiting embodiment of a device for emitting HF signals consistent with the present invention;

FIG. 4 shows a circuit diagram of a third illustrative and non-limiting embodiment of a device for emitting HF signals consistent with the present invention; and

FIG. 5 shows a circuit diagram of a fourth illustrative and non-limiting embodiment of a device for emitting HF signals consistent with the present invention.

### DETAILED DESCRIPTION OF THE PREFERRED EMBODIMENTS

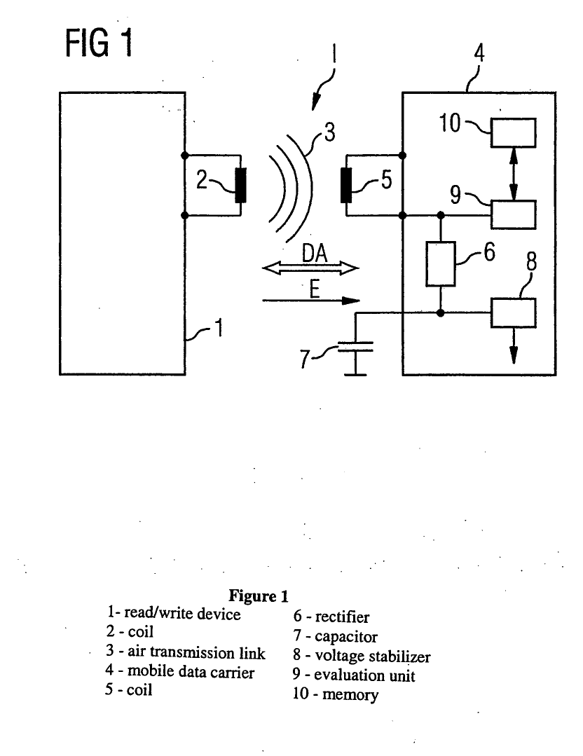

FIG. 1 shows a block diagram of an identification system I, in which a device consistent with the present invention is used. As shown, an identification system I has a read/write device 1 and a mobile data carrier 4. Between the read/write device 1 and the mobile data carrier 4, data DA is exchanged bidirectionally over an air transmission link 3. The read/write device also transmits energy E to the mobile data carrier 4 over the air transmission link 3. This transmission of energy occurs in time intervals when no data is being exchanged. Data and energy are transmitted between the read/write device 1 and the mobile data carrier 4 based on the principle of inductive coupling, such that HF signals are transmitted. For this purpose, the read/write device 1 is equipped with a coil 2 and the mobile data carrier 4 is equipped with a coil 5, each of which serves as an antenna.

In the mobile data carrier 4, the energy transmitted from the read/write device is supplied via a rectifier 6 to an energy storing device, embodied here as a capacitor. The unstabilized DC voltage present at the capacitor 7 is supplied to a voltage stabilizer 8, the output of which provides the stabilized DC voltage required to supply the mobile data carrier 4.

Furthermore, in the mobile data carrier 4, the signal received by the coil 5 is supplied to an evaluation unit 9, in which the data transmitted is analyzed and then routed to a memory 10. The evaluation unit 9 is also provided to generate response signals, which are sent via the coil 5, and are transmitted to the read/write device 1.

The present invention relates, in particular, to a device for emitting HF signals between devices such as the read/write device 1 and the mobile data carrier 4, as implemented in a system like that depicted in FIG. 1.

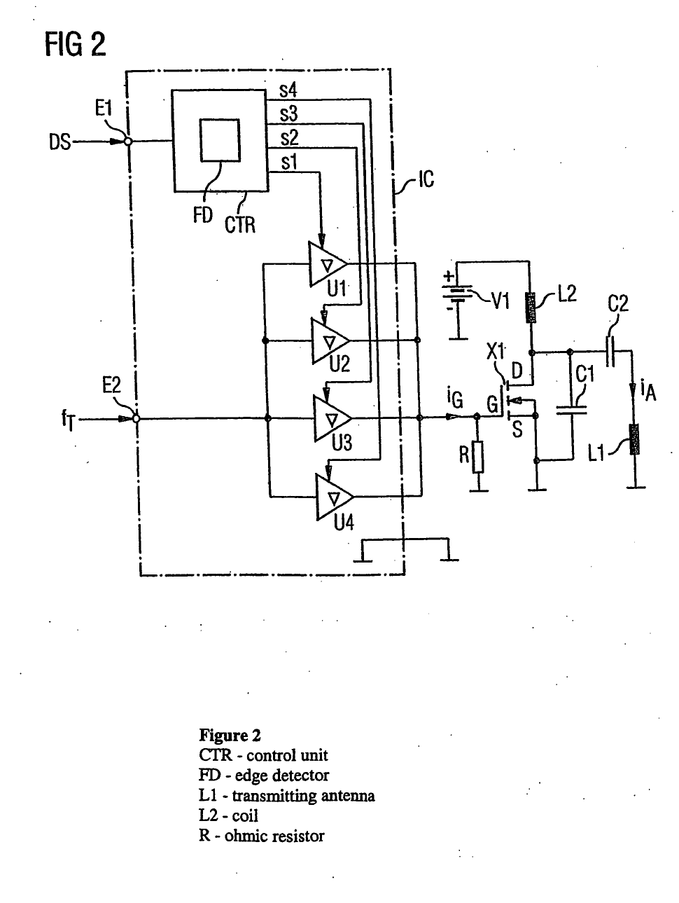

FIG. 2 shows a circuit diagram of a first illustrative and non-limiting embodiment of a device for emitting HF signals consistent with the present invention. The device depicted in FIG. 2 includes a modulator for the amplitude shift keying of input signals, a Class-E amplifier, and a transmitting antenna. The Class-E amplifier and the transmitting antenna are components of the modulator, and the transmitting antenna is a component of the Class-E amplifier.

The modulator includes a digital integrated circuit IC, which in turn has a first input port E1 and a second input port E2. The first input port E1 receives a data signal DS, which is to be modulated so as to consist of a sequence of LOW and HIGH levels, e.g., a sequence of zeros and ones. Additionally, a carrier frequency signal f_{T}, the frequency of which is, for example, 13.56 MHz, is applied to the second input signal port E2.

The carrier frequency signal f_{T} is guided within the digital integrated circuit IC to four gates U1, U2, U3, U4, which are connected in parallel to each other, and form tri-state outputs of the digital integrated circuit IC. The control signals s1, s2, s3, s4 for the gates U1, U2, U3, U4 are provided by a control unit CTR, at the input of which the data signal DS, which is to be modulated, is present. The control unit CTR generates the control signals s1, s2, s3, s4 as a function of the data signal DS, which is to be modulated, such that more or fewer of these gates are conductive, so that a desired gate current i_{G} flows into the gate terminal G of a switching transistor X1.

The switching transistor X1 is a component of a Class-E amplifier and is implemented as a field effect transistor. The source terminal S of the field effect transistor X1 is connected to ground. The source terminal S is further connected via a capacitor C1 to the drain terminal D of the field effect transistor X1. The drain terminal D is further connected via a coil L2 to a DC voltage source V1, which provides a DC supply voltage smaller than 6V. Preferably, the DC voltage source V1 provides a DC supply voltage of 3.3V. This supply voltage, which is low compared to conventional systems, is sufficient in a device consistent with the present invention to transmit HF signals from a read/write device of an identification system to a mobile data carrier. These HF signals are emitted via a coil L1, which in the illustrative and non-limiting embodiment shown in FIG. 2, forms a transmitting antenna and, at the same time, is a component of the Class-E amplifier. The coil L1 is connected via a capacitor C2 to the drain terminal D of the field effect transistor X1. The other terminal of the coil L1 is connected to ground.

In the exemplary device depicted in FIG. 2, the input signal DS, which is to be modulated, is subjected to an amplitude shift keying. This is accomplished by using a plurality of parallel-connected tri-state outputs of a digital integrated circuit IC. These tri-state outputs can be individually connected, disconnected, or switched to a high-resistance state. This occurs as a function of the input signals using a control unit CTR, which provides control signals for the tri-state outputs. These outputs switch the field effect transistor X1 of a Class-E amplifier at the carrier frequency. As a result, a nearly harmonic current with a constant amplitude is generated in the transmitting antenna L1.

This constant amplitude is also determined by the switching speed of the transistor X1. The higher this switching speed is, the lower the losses are in the transistor X1, and the higher the current i_{A} is that flows through the transmitting antenna L1.

To switch the transistor X1, its gate capacitance is charged/discharged. This charging/discharging is effected through the gate current i_{G}, the magnitude of which also depends on the internal resistance of the driver used. Varying the gate current i_{G} changes the switching times and, consequently, also changes the current i_{A} flowing through the transmitting antenna.

The internal resistance can be rendered low by simultaneously switching “ON” several of the tri-state outputs of the digital integrated circuit IC. Conversely, the internal resistance can be increased by switching some of these tri-state outputs to a high-resistance state. The other outputs continue to operate at the carrier frequency clock rate. This reduces the current i_{A} flowing through the transmitting antenna L1. The switching to the high-resistance state occurs at the data clock rate in accordance with the bit sequence of the input signal, that is to be modulated, and a digital bit stream in particular.

If all the gates U1, U2, U3, U4 are conductive, then a high current i_{A} flows through the transmitting antenna L1. If a few of these gates are in a high-resistance state, then the current i_{A} is lower. The state of the gates U1, U2, U3, U4 corresponds to an amplitude shift keying of the current i_{A} flowing through the transmitting antenna L1, and of the magnetic field generated by this current.

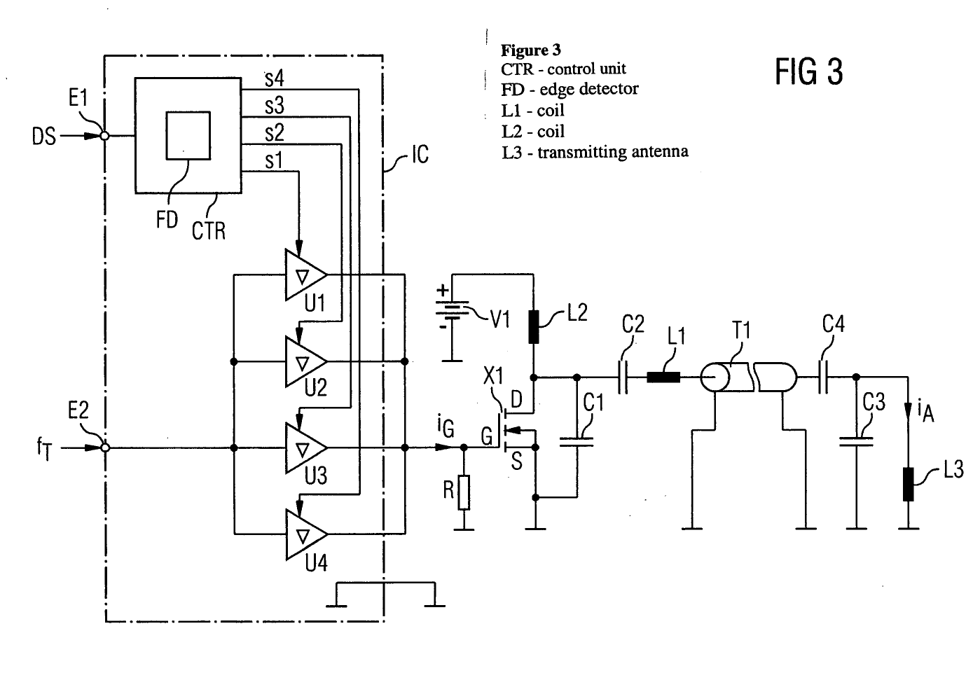

FIG. 3 shows a circuit diagram of a second illustrative and non-limiting embodiment of a device for emitting HF signals consistent with the present invention. The device depicted in FIG. 3, which corresponds in many respects to the device shown in FIG. 2, includes a modulator for the amplitude shift keying of input signals, a Class-E amplifier, and a transmitting antenna L3. The Class-E amplifier is a component of the modulator, and the transmitting antenna L3 is further connected to the Class-E amplifier via a line T1, and to a matching network including C3 and C4.

The modulator includes a digital integrated circuit IC, which in turn has a first input port E1 and a second input port E2. A data signal DS is supplied to the first input port E1. The data signal DS, which is to be modulated, consists of a sequence of LOW and HIGH levels, e.g., a sequence of zeros and ones. Further, a carrier frequency signal f_{T}, the frequency of which is, for example, 13.56 MHz, is applied to the second input signal port E2.

The carrier frequency signal f_{T} is guided within the digital integrated circuit IC to four gates U1, U2, U3, U4, which are connected in parallel to each other, and form tri-state outputs of the digital integrated circuit IC. The control signals s1, s2, s3, s4 for the gates U1, U2, U3, U4 are provided by a control unit CTR, at the input of which the data signal DS, which is to be modulated, is present. The control unit CTR generates the control signals s1, s2, s3, s4 as a function of the data signal DS, which is to be modulated, such that more or fewer of the gates U1, U2, U3, U4 are conductive, so that a desired gate current i_{G} flows into the gate terminal G of a switching transistor X1.

The switching transistor X1 is a component of a Class-E amplifier and is implemented as a field effect transistor. The source terminal S of the field effect transistor X1 is connected to ground. The source terminal S is further connected via a capacitor C1 to the drain terminal D of the field effect transistor X1. The drain terminal D is further connected via a coil L2 to a DC voltage source V1, which provides a DC supply voltage smaller than 6V. Preferably, the DC voltage source V1 provides a DC supply voltage of 3.3V. This supply voltage, which is low compared to conventional systems, is sufficient in a device consistent with the present invention to transmit HF signals from a read/write device of an identification system to a mobile data carrier. Such HF signals are emitted via the coil L3, which in the illustrative and non-limiting embodiment shown in FIG. 3, forms a transmitting antenna, and is connected to the Class-E amplifier via the line T1 and the matching network including C3 and C4. The other terminal of the coil L3 is connected to ground. Further, the drain terminal D of the field effect transistor X1 is connected to the line T1 via a capacitor C2 and a coil L1 connected in series thereto.

In the exemplary device depicted in FIG. 3, the input signal DS, which is to be modulated, is subjected to an amplitude shift keying. This is accomplished by using a plurality of parallel-connected tri-state outputs of a digital integrated circuit IC. These tri-state outputs can be individually connected, disconnected, or switched to a high-resistance state. This is accomplished as a function of the input signals using a control unit CTR, which provides control signals for the tri-state outputs. These outputs switch the field effect transistor X1, of the Class-E amplifier, at the carrier frequency rate. As a result, a nearly harmonic current with constant amplitude is generated in the transmitting antenna L3.

This constant amplitude is also determined by the switching speed of the transistor X1. The higher this switching speed is, the lower the losses are in the transistor X1, and the higher the current i_{A} is that flows through the transmitting antenna L3.

To switch the transistor X1, its gate capacitance is charged/discharged. This charging/discharging occurs through the gate current i_{G}, the magnitude of which also depends on the internal resistance of the driver used. Varying the gate current i_{G} changes the switching times and, consequently, also changes the current i_{A} flowing through the transmitting antenna L3.

The internal resistance can be rendered low by simultaneously switching “ON” several of the tri-state outputs of the digital integrated circuit IC. Conversely, the internal resistance can be increased by switching some of these tri-state outputs to a high-resistance state. The other outputs continue to operate at the carrier frequency clock rate. As a result, the current i_{A} flowing through the transmitting antenna L3 is reduced. The switching to the high-resistance state occurs at the data clock rate, in accordance with the bit sequence of the input signal that is to be modulated, which is, in particular, a digital bit stream.

If all the gates U1, U2, U3, U4 are conductive, then a high current i_{A} flows through the transmitting antenna L3. If some of these gates are in a high-resistance state, then the current i_{A} is lower. The state of the gates U1, U2, U3, U4 corresponds to an amplitude shift keying of the current i_{A} flowing through the transmitting antenna L3, and of the magnetic field generated by this current.

A device according to FIG. 3 can be implemented, in particular, if the transmitting antenna cannot be arranged in the immediate proximity of the modulator, or the digital integrated circuit IC, or the Class-E amplifier for design reasons. The matching network having the capacitors C3 and C4 serves to match the Class-E amplifier and the antenna to the ohmic resistor of the line T1.

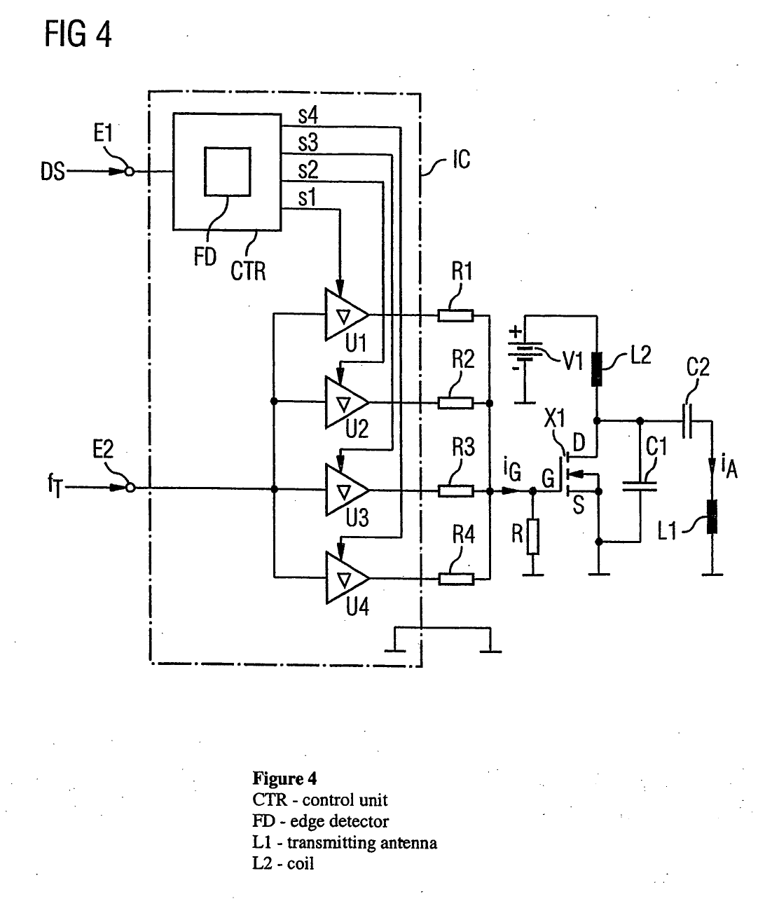

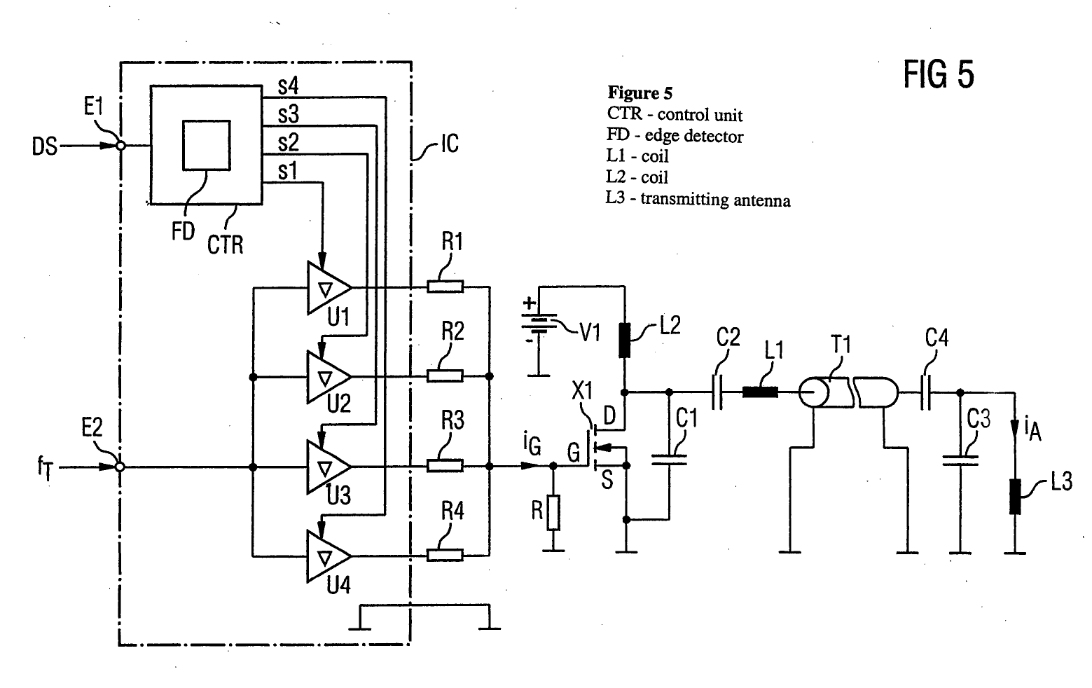

FIG. 4 shows a circuit diagram of a third illustrative and non-limiting embodiment of a device for emitting HF signals consistent with the present invention. The device depicted in FIG. 5, which corresponds in many respects to the device shown in FIG. 2, includes a modulator for the amplitude shift keying of input signals, a Class-E amplifier, and a transmitting antenna. The Class-E amplifier and the transmitting antenna are components of the modulator, and the transmitting antenna is a component of the Class-E amplifier.

The modulator includes a digital integrated circuit IC, which in turn has a first input port E1 and a second input port E2. A data signal DS is supplied to the first input port E1. The data signal DS, which is to be modulated, consists of a sequence of LOW and HIGH levels, e.g., a sequence of zeros and ones. In addition, a carrier frequency signal f_{T}, the frequency of which is, for example, 13.56 MHz, is applied to the second input signal port E2.

The carrier frequency signal f_{T} is guided within the digital integrated circuit IC to four gates U1, U2, U3, U4, which are connected in parallel to each other, and form tri-state outputs of the digital integrated circuit IC. The control signals s1, s2, s3, s4 for the gates U1, U2, U3, U4 are provided by a control unit CTR, at the input of which the data signal DS, which is to be modulated, is present. The control unit CTR generates the control signals s1, s2, s3, s4 as a function of the data signal DS, which is to be modulated, such that more or fewer of the gates U1, U2, U3, U4 are conductive, so that a desired gate current i_{G} flows into the gate terminal G of a switching transistor X1. With the ohmic resistors R1, R2, R3, R4, one of these resistors being connected in series on the load side of each gate, a different weighting is achieved, and the number of possible gate currents i_{G} of the switching transistor X1 is further increased.

The switching transistor X1 is a component of a Class-E amplifier and is implemented as a field effect transistor. The source terminal S of the field effect transistor X1 is connected to ground. The source terminal S is further connected via a capacitor C1 to the drain terminal D of the field effect transistor X1. The drain terminal D is further connected via a coil L2 to a DC voltage source V1, which provides a DC supply voltage smaller than 6V. Preferably, the DC voltage source V1 provides a DC supply voltage of 3.3V. This supply voltage, which is low compared to conventional systems, is sufficient in a device consistent with the present invention to transmit HF signals from the read/write device of an identification system to a mobile data carrier. These HF signals are emitted via a coil L1, which in the illustrative and non-limiting embodiment depicted in FIG. 4, forms a transmitting antenna and, at the same time, is a component of the Class-E amplifier. The coil L1 is connected via a capacitor C2 to the drain terminal D of the field effect transistor X1. The other terminal of the coil L1 is connected to ground.

In the exemplary device depicted in FIG. 4, the input signal DS, which is to be modulated, is subjected to an amplitude shift keying. This is accomplished by using a plurality of parallel-connected tri-state outputs of a digital integrated circuit IC. These tri-state outputs can be individually connected, disconnected, or switched to a high-resistance state. This occurs as a function of the input signals by means of a control unit CTR, which provides control signals for the tri-state outputs. These outputs switch the field effect transistor X1 of a Class-E amplifier at the carrier frequency rate. As a result, a nearly harmonic current with constant amplitude is produced in the transmitting antenna L1.

This constant amplitude is also determined by the switching speed of the transistor X1. The higher this switching speed is, the lower the losses are in the transistor X1, and the higher the current i_{A} is that flows through the transmitting antenna L1.

To switch the transistor X1, its gate capacitance is charged/discharged. This charging/discharging is effected through the gate current i_{G}, the magnitude of which also depends on the internal resistance of the driver used. Varying the gate current i_{G} changes the switching times and, consequently, also changes the current i_{A} flowing through the transmitting antenna.

The internal resistance can be decreased by simultaneously switching “ON” a plurality of the tri-state outputs of the digital integrated circuit IC. Conversely, the internal resistance can be increased by switching some of these tri-state outputs to a high-resistance state. The other outputs continue to operate at the carrier frequency clock rate. As a result, the current i_{A} flowing through the transmitting antenna L1 is reduced. The switching to the high-resistance state occurs at the data clock rate in accordance with the bit sequence of the input signal that is to be modulated, which is, in particular, a digital bit stream.

If all the gates U1, U2, U3, U4 are conductive, then a high current i_{A} flows through the transmitting antenna L1. If some of these gates are in a high-resistance state, then the current i_{A} is lower. The state of the gates U1, U2, U3, U4 corresponds to an amplitude shift keying of the current i_{A} flowing through the transmitting antenna L1, and to the magnetic field generated by this current.

FIG. 5 shows a circuit diagram of a fourth illustrative and non-limiting embodiment of a device for emitting HF signals consistent with the present invention. The exemplary device depicted in FIG. 5, which corresponds in many respects to the device shown in FIG. 2, includes a modulator for the amplitude shift keying of input signals, a Class-E amplifier, and a transmitting antenna. The Class-E amplifier is a component of the modulator, and the transmitting antenna L3 is connected to the Class-E amplifier via a line T1 and a matching network including C3 and C4.

The modulator includes a digital integrated circuit IC, which in turn has a first input port E1 and a second input port E2. A data signal DS is supplied to the first input port E1. The data signal DS, which is to be modulated consists of a sequence of LOW and HIGH levels, e.g., a sequence of zeros and ones. Moreover, a carrier frequency signal f_{T}, the frequency of which is, for example, 13.56 MHz, is applied to the second input signal port E2.

The carrier frequency signal f_{T} is guided within the digital integrated circuit IC to four gates U1, U2, U3, U4, which are connected in parallel to each other, and form tri-state outputs of the digital integrated circuit IC. The control signals s1, s2, s3, s4 for the gates U1, U2, U3, U4 are provided by a control unit CTR, at the input of which the data signal DS, which is to be modulated, is present. The control unit CTR generates the control signals s1, s2, s3, s4 as a function of the data signal DS, which is to be modulated, such that more or fewer of these gates are conductive, so that a desired gate current i_{G} flows into the gate terminal G of a switching transistor X1. Through the ohmic resistors R1, R2, R3, R4, one of these resistors being connected in series on the load side of each gate, a different weighting is achieved, and the number of the possible gate currents i_{G} of the switching transistor X1 is further increased as a result.

The switching transistor X1 is a component of a Class-E amplifier and is implemented as a field effect transistor. The source terminal S of the field effect transistor X1 is connected to ground. The source terminal S is further connected via a capacitor C1 to the drain terminal D of the field effect transistor X1. The drain terminal D is further connected via a coil L2 to a DC voltage source V1, which provides a DC supply voltage smaller than 6V. Preferably, the DC voltage source V1 provides a DC supply voltage of 3.3V. This supply voltage, which is low compared to conventional systems, is sufficient in a device consistent with the present invention to transmit HF signals from the read/write device of an identification system to a mobile data carrier. These HF signals are emitted via a coil L3, which in the illustrative and non-limiting embodiment shown in FIG. 5, forms a transmitting antenna, and is connected to the Class-E amplifier via the line T1 and the matching network including C3 and C4. The other terminal of the coil L3 is connected to ground. The drain terminal D of the field effect transistor X1 is connected to the line T1 via a capacitor C2 and a coil L1 connected in series thereto.

In the exemplary device depicted in FIG. 5, the input signal DS, which is to be modulated, is subjected to an amplitude shift keying. This is accomplished by using a plurality of parallel-connected tri-state outputs of a digital integrated circuit IC. These tri-state outputs can be individually connected, disconnected, or switched to a high-resistance state. This occurs as a function of the input signals by means of a control unit CTR, which provides control signals for the tri-state outputs. These outputs switch the field effect transistor X1 of a Class-E amplifier at the carrier frequency rate. As a result, a nearly harmonic current with constant amplitude is generated in the transmitting antenna L3.

This constant amplitude is also determined by the switching speed of the transistor X1. The higher this switching speed is, the lower the losses are in the transistor, and the higher the current i_{A} is that flows through the transmitting antenna L3.

To switch the transistor X1 its gate capacitance is charged/discharged. This charging/discharging is effected through the gate current i_{G}, the magnitude of which also depends on the internal resistance of the driver used. Varying the gate current i_{G} changes the switching times and, consequently, also the current i_{A} flowing through the transmitting antenna L3.

The internal resistance can be decreased by simultaneously switching “ON” a plurality of the tri-state outputs of the digital integrated circuit IC. Conversely, the internal resistance can be increased by switching some of these tri-state outputs to a high-resistance state. The other outputs continue to operate at the carrier frequency clock rate. As a result, the current i_{A} flowing through the transmitting antenna L3 is reduced. The switching to the high-resistance state occurs at the data clock rate in accordance with the bit sequence of the input signal, which is to be modulated, and which is a digital bit stream.

If all of the gates U1, U2, U3, U4 are conductive, then a high current i_{A} flows through the transmitting antenna L3. If some of these gates are in a high-resistance state, then the current i_{A} is lower. The state of the gates U1, U2, U3, U4 corresponds to an amplitude shift keying of the current i_{A} flowing through the transmitting antenna L1, and to the magnetic field generated by this current.

A device consistent with that shown in FIG. 5 can be used, in particular, if the transmitting antenna cannot be arranged in the immediate proximity of the modulator, or the digital integrated circuit IC, or the Class-E amplifier for design reasons. The matching network including the capacitors C3 and C4 serves to match the Class-E amplifier and the antenna to the ohmic resistance of the line T1.

Thus, the present invention relates to a device for emitting HF signals, which includes a modulator for the amplitude shift keying of input signals, a Class-E amplifier as the transmitting amplifier, and a transmitting antenna. The Class-E amplifier is highly efficient and requires only a low DC supply voltage, which is, for example, 3.3V Additionally, a device consistent with the present invention requires fewer components for its implementation compared to conventional devices for emitting HF signals. Moreover, the transmitting antenna can be a component of the Class-E amplifier, so that the number of required components is further reduced. Alternatively, the transmitting antenna can be connected to the Class-E amplifier via a line and a matching network.

The current flowing through the antenna can be readily adjusted during operation, as a function of the input signals, by software commands via the number of the active digital outputs of the integrated digital circuit. This makes it possible to achieve the desired amplitude shift keying and to change the output current. The claimed device can be readily integrated into a digital environment, e.g., a field-programmable gate array (“FPGA”). Such integration does not require a clock faster than the carrier frequency.

As may be seen from the above description, a device consistent with the present invention may be carried out as a function of the control of the tri-state outputs or gates, as well as an amplitude shift keying with one modulation depth, i.e., two levels of the output current, as well as an amplitude shift keying with more than one modulation depth, i.e., more than two levels of the output current.

An advantageous further refinement of the present invention consists in equipping the control unit CTR, arranged in the digital integrated circuit IC, with an edge detector FD, and taking into account the output signals of the edge detector FD when determining the control signals s1, s2, s3, s4. This makes it possible to make the falling and rising edges of the envelope curve steeper.

In all of the above-described illustrative and non-limiting embodiments, a high-resistance ohmic resistor R is provided between the gate G of the switching transistor X1 and the ground. This resistor R has no influence during regular operation of the corresponding device. However, when the digital integrated circuit IC is without power because of an error, or when the power supply is connected and disconnected, this ohmic resistor R blocks the switching transistor X1 and prevents an open gate with an undefined level.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

1. A device for emitting high-frequency signals, comprising:
a modulator configured to perform amplitude shift keying of input signals;
a Class-E amplifier which is connected to the modulator; and
a transmitting antenna.

2. The device as claimed in claim 1, wherein the Class-E amplifier comprises a switching transistor, which is controlled with varying power as a function of the input signals.

3. The device as claimed in claim 2, wherein the switching transistor is a field effect transistor.

4. The device as claimed in claim 3, wherein a drain terminal of the field effect transistor is connected via a coil to a DC voltage source.

5. The device as claimed in claim 1, wherein the input signals are supplied to the Class-E amplifier via a digital integrated circuit, which comprises a plurality of parallel tri-state outputs, which are individually connected, disconnected, or switched to a high-resistance state as a function of the input signals.

6. The device as claimed in claim 5, wherein the digital integrated circuit comprises a control unit, which generates control signals for the tri-state outputs.

7. The device as claimed in claim 6, wherein the digital integrated circuit comprises an edge detector and the control unit generates the control signals for the tri-state outputs as a function of edges detected by the edge detector which are contained in the input signals.

8. The device as claimed in claims 6, wherein the control unit generates the control signals for the tri-state outputs in such a way that an amplitude shift keying occurs with more than one modulation depth.

9. The device as claimed in claim 1, wherein the transmitting antenna comprises a coil of the Class-E amplifier.

10. The device as claimed in claim 1, wherein the Class-E amplifier is connected to the transmitting antenna via a line and a matching network.

11. An identification system, comprising:
a read/write device;
a mobile data carrier; and
a device for emitting high-frequency signals, comprising:
a modulator configured to perform amplitude shift keying of input signals;
a Class-E amplifier which is connected to the modulator; and
a transmitting antenna.

12. The identification system as claimed in claim 11, wherein the Class-E amplifier comprises a switching transistor, which is controlled with varying power as a function of the input signals;
wherein the switching transistor is a field effect transistor; and
wherein a drain terminal of the field effect transistor is connected via a coil to a DC voltage source.

13. The identification system as claimed in claim 12, wherein the DC voltage source connected via the coil to the drain terminal of the field effect transistor provides a supply voltage smaller than 6V.

14. The identification system as claimed in claim 13, wherein the supply voltage is approximately 3.3V.

15. The device as claimed in claim 5, wherein ohmic resistors are connected in series to the tri-state outputs.

16. The identification system as claimed in claim 15, wherein the ohmic resistors have differing resistance values.
